(19) United States
(12) Patent Application Publication
(10) Pub. No.: US 2020/0309590 A1
(43) Pub. Date: Oct. 1, 2020

(54) SELF WEIGHING LUGGAGE BAG

(71) Applicants: Jeff S Magsitza, Pomona, NY (US); Kelly Law, Kowloon (CN)

(72) Inventors: Jeff S Magsitza, Pomona, NY (US); Kelly Law, Kowloon (CN)

(21) Appl. No.: 16/825,015

(22) Filed: Mar. 20, 2020

Related U.S. Application Data
(60) Provisional application No. 62/823,153, filed on Mar. 25, 2019.

(51) Int. Cl. G01G 19/52; A45C 5/03; A45C 15/00; A45C 5/14; A45C 13/10

(52) U.S. Cl. CPC G01G 19/52; A45C 5/03; A45C 13/103; A45C 5/14; A45C 15/00

(57) ABSTRACT

A luggage bag which is able to weigh itself when the bag is opened during packing so as to be able to determine if airline weight limits have been exceeded while the bag is open and being packed.

### CROSS REFERENCE TO RELATED APPLICATION

This application claims the benefit of U.S. provisional application No. 62/823,153, filed Mar. 25, 2019 which is incorporated herein by reference

### BACKGROUND OF THE INVENTION

This invention concerns luggage bags having a self weighing capability and displaying the weight of the luggage bag when being packed.

Airlines charge passengers significant fees for luggage pieces that exceed a predetermined maximum weight, and travelers have become concerned about such charges.

A traveler can weigh packed bags at home and remove one or more packed articles to avoid such charges.

However, this is a tedious task since the bag must first be reopened to remove or add items and thus there has heretofore been proposed various gadgets and systems to facilitate the process.

U.S. Pat. No. 8,901,442 describes a system where the weight of packed articles is determined during the packing of the luggage so as to determine the total weight of the packed luggage. This is done with a luggage piece which has an inner and an outer nested container and a sensor is located between the two containers which acts to weigh the inner container with its contents.

This approach adds to the weight of the luggage piece and occupies a significant part of the space available. Also, the weighing system may not be as accurate as desirable as friction between the inner and outer containers affects the accuracy of the weight determination.

There are many inconvenient other gadgets and scales which have the inconvenience of closing and opening the luggage just to see how much it weighs.

Other products on the market are gadgets that you have to lift or close the luggage bag to weigh it by placing sensors on the outside; we are able to get a more accurate reading without using up packing space.

The traveler then has the option to add more articles or take out something from the packed contents inside the case so that it is lightened and not overweight.

### SUMMARY OF THE INVENTION

The present invention provides an improved accuracy weighing system incorporated in a luggage bag which system is located mostly externally on the luggage bag and only occupies a small space within the luggage bag.

The luggage bag is comprised of two stacked cases which are hinged together along one side to be face to face with each other when closed as by use of a zipper, and is opened by the two cases being swung apart when unzipped to expose side by side spaces both of which may receive articles to be packed.

The outside of the bottom of each case is provided with an external pressure surface, each surface having a set of four weight sensors forming a quadrilateral thereon.

The total weight sensed by all of the weight sensors is continuously determined electronically as by a summing signal processor, and the total weight of the luggage bag and its packed contents is continuously available to be displayed while the luggage bag is open.

Thus, when one case is swung open, the interior of both cases are exposed, and ready to be packed. As items are added or removed as the packing of the luggage bag cases proceeds, the total weight may be immediately displayed when adding or removing an article from either of the cases.

Thus, the traveler can determine if he or she has packed too many items and allows the removal of selected articles from the opened cases thereby to prevent overweighting the luggage bag.

All eight sensors being outside of the inner storage space of the luggage piece achieves the best accuracy and occupies less interior space in the luggage bag.

The whole system only occupies a very minor part of the interior volume of the luggage piece.

Moreover, the whole assembly is bonded together in a PCB plastic which provides light weight as well improved accuracy.

The sensors are battery powered, so in accordance with the air line safety protocol, two AAA batteries are used instead of a lithium battery.

### DESCRIPTION OF THE DRAWINGS

FIG. 1 is a side view of a luggage bag according to the invention in the closed up condition.

FIG. 2 is a front view of luggage bag shown in FIG. 1.

FIG. 3 is an end view of two opened cases constituting the luggage bag are laid flat on a hard surface.

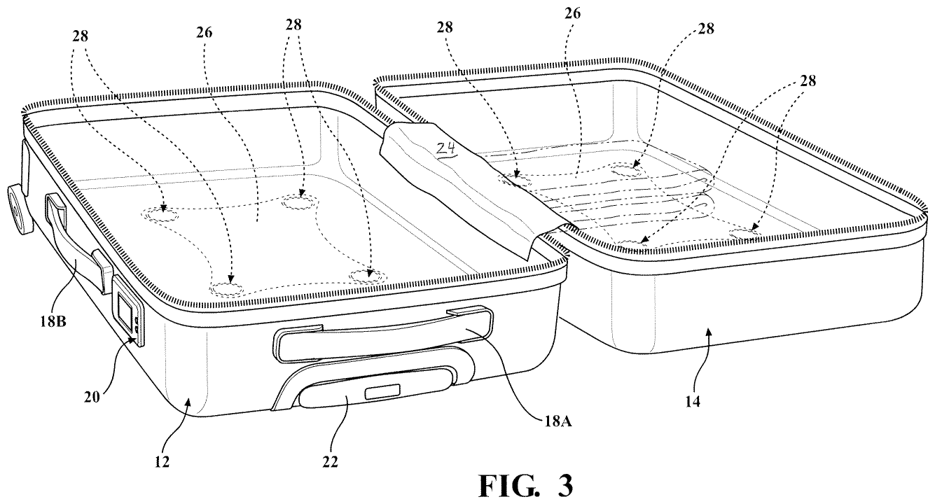

FIG. 4 is a perspective view of the luggage bag shown in FIGS. 1 and 2 with the two cases unzipped and laid flat.

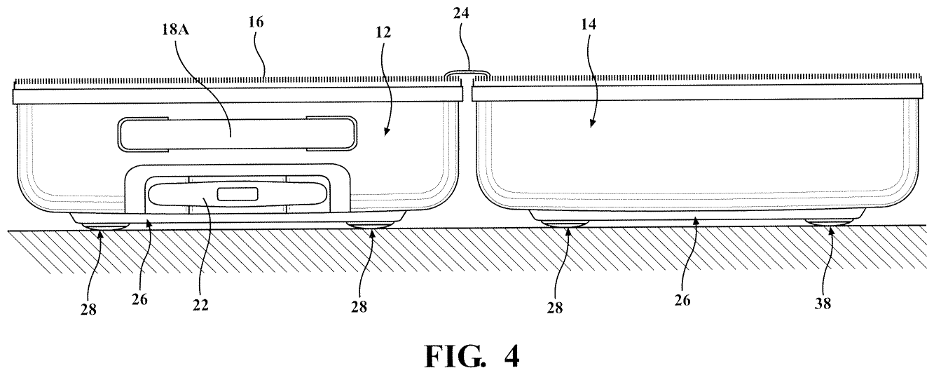

FIG. 5 is an enlarged outer view of the display screen with associated connections and a summing signal processor depicted schematically.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

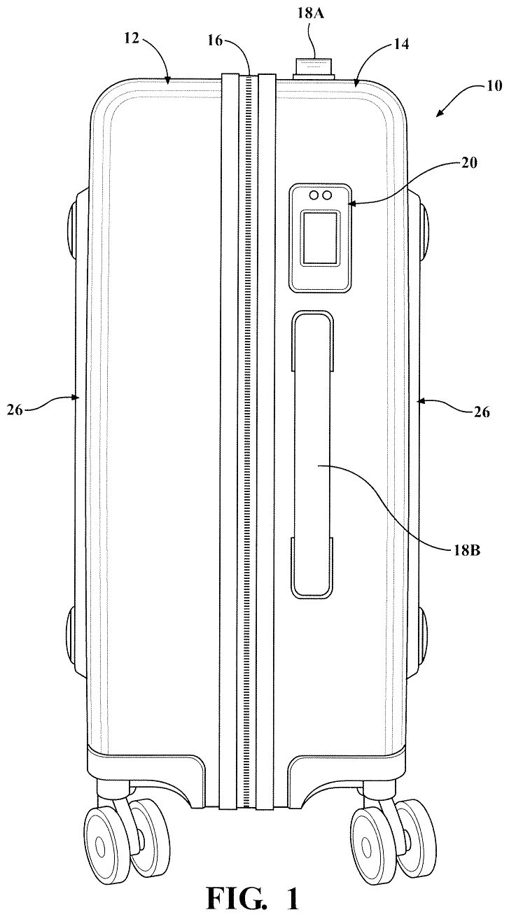

Referring to FIG. 1 in the drawings, the luggage bag 10 which may be wheeled as shown has two separate storage cases 12, 14 able to be connected together facing each other as with a zipper 16.

Handles 18A, 18B may be provided at the top and the side of one of the cases 14. Feet 25 are provided when resting the bag 10 on its side. An extendable handle 22 may be provided as per the usual practice for wheeled bags.

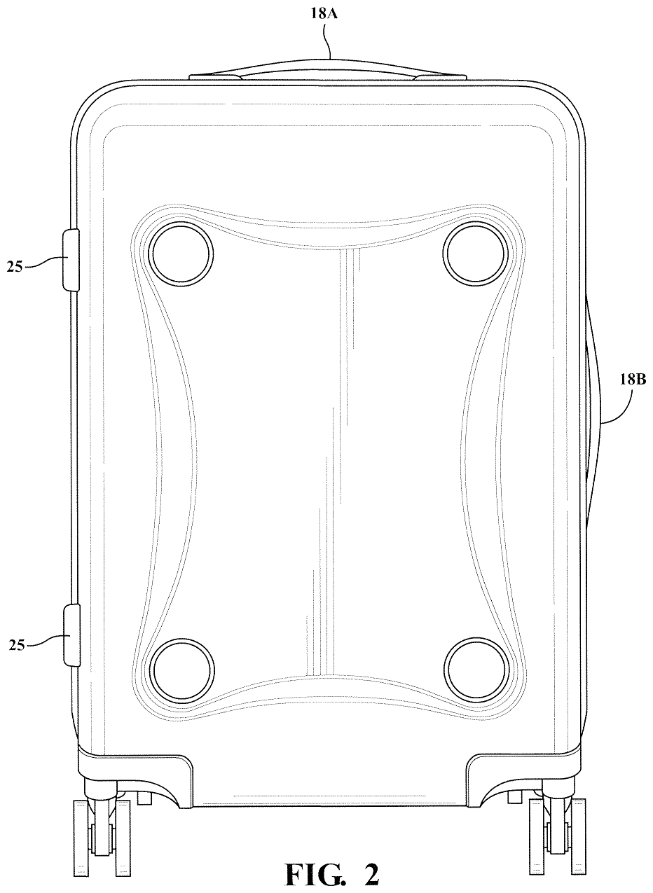

An LED display 20 is located on one side of one of the cases 14 so as to be viewable when the cases 12, 14 are unzipped and laid flat side by side, connected together along one side as with a fabric strip 24 or other connection as seen in FIG. 2.

Two AAA batteries 54 are in a housing 52 behind the LED display 20 but within the casing 14.

A pressure surface 26 is integrally formed (or being a plate separately mounted thereto) is on the outside of each case 12, 14.

Four commercially available weight sensors 28 are arranged in a quadrilateral pattern on each pressure surface 26 the quadrilateral pattern prevents slight tipping which possibly could contact the surface on which the cases 12, 14 rest, possibly causing a significant error by reducing the total sensed weight.

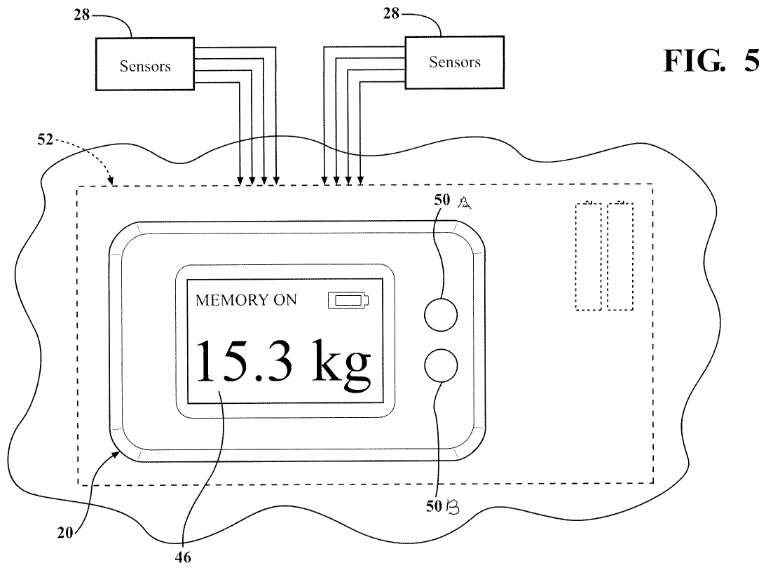

FIG. 5 shows the details of the sensor mountings. It should be understood that such weight sensors are commercially available for scales, etc. and can be used in the present invention.

FIG. 5 shows the LED display 20 which includes a screen 36 displaying the total weight sensed by all of the sensors 28. All of the signals from the sensors 28 are transmitted to a summing signal processor 32 which could include suitable software wherein a total weight is determined and transmitted to the display 20.

An on/off control button 50A is also provided as well as a unit change button 50B (lbs to Kg).

1. A luggage bag comprised of two cases pivotally connected together along one side to be able to be swung apart to allow the cases to be pivoted open by swinging about the connected side so that the cases are positioned side by side with an open top allowing items to be placed therein when packing;
each case having an arrangement of weight sensors mounted on a side surface and producing electronic signals corresponding to the total weight of each case including packed contents therein;
a summing processor receiving and summing said signals to produce a signal corresponding to the total weight of said both cases with any contents packed therein; and
a numeric display visible to a user when receiving said total weight sensor signals and producing a numeric display thereby located on one side of one of said cases so as to be visible to a person packing said opened cases.

2. The luggage bag according to claim 1 wherein said sensor arrangements comprise four spaced apart weight sensors arranged in a quadrilateral pattern on an outer side of each case which is on the bottom surface of each case when said luggage cases are swung open and lying on a supporting surface.

3. The luggage bag according to claim 1 wherein a surface is on a bottom wall of each case when swung open and said sensors are located so as to be arranged in a quadrilateral pattern thereon.
